(19) United States
(12) Patent Application Publication
(10) Pub. No.: US 2015/0368130 A1
(43) Pub. Date: Dec. 24, 2015

(54) PROCESS FOR PURIFICATION TREATMENT OF WASTEWATER AND APPARATUS FOR PURIFICATION TREATMENT OF WASTEWATER

(71) Applicant: SUMITOMO ELECTRIC INDUSTRIES, LTD., Osaka-shi, Osaka (JP)

(72) Inventors: Kenichi USHIKOSHI, Osaka-shi (JP); Toru MORITA, Sennan-gun (JP); Masao KOMATSU, Kobe-shi (JP); Teizo MIZUTANI, Neyagawa-shi (JP)

(73) Assignee: SUMITOMO ELECTRIC INDUSTRIES, LTD., Osaka-shi, Osaka (JP)

(21) Appl. No.: 14/765,088

(22) PCT Filed: Jun. 30, 2014
(86) PCT No.: PCT/JP2014/067316

§ 371 Date: Jul. 31, 2015

(30) Foreign Application Priority Data
Jul. 4, 2013 (JP) 2013-141156

(51) Int. Cl. C02F 3/12

(52) U.S. Cl. CPC C02F 3/1268; C02F 2103/02

(57) ABSTRACT

A process for purification treatment of wastewater according to the present invention is a process for conducting a purification treatment of wastewater containing polyvinyl alcohol by using a membrane bioreactor process, the process including adding a nutrient to a treatment system. The nutrient is preferably added to an aeration tank. The nutrient preferably contains nitrogen. An amount of the nutrient initially added is preferably 5% or more and 25% or less in terms of nitrogen. The process for purification treatment of wastewater preferably includes a step of measuring a nitrogen content after a treatment, and an amount of the nutrient added is preferably adjusted on the basis of the result of this measurement while checking the effect on the basis of a chemical oxygen demand. The nutrient may be added to the aeration tank by a mechanism that adds the nutrient to the treatment system or by feeding the nutrient manually to the treatment system.

### TECHNICAL FIELD

The present invention relates to a process for purification treatment of wastewater and an apparatus for purification treatment of wastewater.

### BACKGROUND ART

In purification treatments of wastewater such as industrial wastewater, animal waste, and sewage water, activated sludge processes, which have high treatment efficiencies, are widely used. In particular, a membrane bioreactor process (MBR process) has attracted attention in which separation of treated water and sludge is conducted by using a microfiltration membrane (MF membrane) or an ultra-filtration membrane (UF membrane) instead of using an existing precipitation method. Examples of purification treatment apparatuses for the MBR process include separate installation-type apparatuses including an aeration tank and a membrane separation tank, and single tank-type apparatuses in which a separation membrane is immersed in a reaction tank.

The aeration tank is a tank for purifying wastewater in which a large number of propagated microorganisms are used to capture and consume contamination substances, which are mainly organic substances, in the wastewater. A mass of such microorganisms having a capability of purifying wastewater is referred to as activated sludge. The term “aeration” means that air is passed through water to supply oxygen. In some cases, oxygen is required for microorganisms to survive. Thus, in the activated sludge process, aeration is performed by supplying air from a lower portion of an aeration tank to the aeration tank using a blower or by stirring the surface of the aeration tank.

The separation membrane separates water (treated water) purified in the aeration tank and activated sludge. However, clogging (fouling) is inevitably caused by the activated sludge.

The following process has been proposed as a means for preventing such fouling. For example, with regard to oil contained in activated sludge, a pretreatment method for removing oil contained in wastewater and the treatment conditions of activated sludge are determined on the basis of biodegradability and kinetic viscosity of the oil. The process for stably operating a membrane bioreactor (MBR) without clogging of the separation membrane with oil, as described above, has been proposed (Japanese Unexamined Patent Application Publication No. 2011-177608).

### CITATION LIST

### Patent Literature

### PTL 1: Japanese Unexamined Patent Application Publication No. 2011-177608

### SUMMARY OF INVENTION

### Technical Problem

Industrial wastewater in the dyeing industry or the like contains polyvinyl alcohol (PVA). PVA is not easily degraded, and thus, in the case where wastewater containing PVA is purified in an MBR, PVA is easily concentrated and adheres to the upstream side of a separation membrane. In addition, since PVA is in a viscous form, PVA accelerates clogging (fouling) of the separation membrane within a short time. This clogging of the separation membrane causes an increase in the differential pressure between the upstream side and the downstream side of the separation membrane, and degrades filtration characteristics. Furthermore, undegraded PVA and other contamination substances flow into treated water, resulting in degraded water quality of the treated water.

Regarding the above existing process of operating an MBR while suppressing clogging of the separation membrane, it is difficult to apply the process to the treatment of industrial wastewater that contains PVA, and the process cannot satisfactorily prevent clogging due to PVA.

The present invention has been made in view of the above circumstances. An object of the present invention is to provide a process for stably conducting a wastewater purification treatment while suppressing the occurrence of fouling when a purification treatment of wastewater containing PVA is conducted by using an MBR, and to provide an apparatus for stably conducting the wastewater purification treatment.

### Solution to Problem

An invention made to solve the above problem provides

a process for purification treatment of wastewater for conducting a purification treatment of wastewater containing polyvinyl alcohol by using a membrane bioreactor process (MBR process),

the process including adding a nutrient to a treatment system.

Another invention made to solve the above problem provides

an apparatus for conducting a purification treatment of wastewater containing polyvinyl alcohol by using a membrane bioreactor process,

the apparatus including a mechanism that adds a nutrient to a treatment system.

### Advantageous Effects of Invention

The process for purification treatment of wastewater and the apparatus for purification treatment of wastewater according to the present invention can increase the bacterial concentration of microorganisms that degrade PVA (PVA-degrading bacteria) and activate the action of the PVA-degrading bacteria. Accordingly, degradation of PVA proceeds, fouling does not easily occur, and the treatment state of PVA can be satisfactorily maintained.

### BRIEF DESCRIPTION OF DRAWINGS

FIG. 1 is a block diagram of an apparatus for purification treatment of wastewater according to an embodiment of the present invention.

FIG. 2 is a block diagram of an apparatus for purification treatment of wastewater according to another embodiment of the present invention.

FIG. 3 is a block diagram of an apparatus for purification treatment of wastewater according to another embodiment of the present invention.

### REFERENCE SIGNS LIST

1 aeration tank
2 membrane separation tank
3 suction pump
4 measurement unit
5 adjustment unit
6 nutrient addition mechanism
7 separation membrane
8 wastewater
9 treated water
10 sludge
11 nutrient
12 anaerobic tank
13 anoxic tank
14 oxic tank
15 aeration tank
16 separation membrane

### DESCRIPTION OF EMBODIMENTS

### Description of Embodiments of the Present Invention

An invention made to solve the above problem provides

a process for purification treatment of wastewater for conducting a purification treatment of wastewater containing polyvinyl alcohol by using a membrane bioreactor process,

the process including adding a nutrient to a treatment system.

In the purification treatment process, by adding a nutrient to the treatment system, the bacterial concentration can be increased by activation of PVA-degrading bacteria and membrane separation, and the action of the PVA-degrading bacteria can be activated by the addition of the nutrient. Consequently, degradation of PVA proceeds, and the occurrence of fouling is suppressed.

The process for purification treatment of wastewater preferably includes a microorganism treatment step of aerating the wastewater, in which the nutrient is added in the microorganism treatment step. By adding the nutrient in the microorganism treatment step, the bacterial concentration of PVA-degrading bacteria can be effectively increased, and degradation of PVA can be further accelerated.

The process for purification treatment of wastewater preferably includes a step of measuring a nitrogen content after a treatment, in which an amount of the nutrient added is adjusted on the basis of the nitrogen content determined in the measurement step. By adjusting the amount of the nutrient added on the basis of the nitrogen content of treated water, the treatment state of PVA can be more satisfactorily maintained.

Another invention made to solve the above problem provides

an apparatus for conducting a purification treatment of wastewater containing polyvinyl alcohol by using a membrane bioreactor process,

the apparatus including a mechanism that adds a nutrient to a treatment system.

In the above apparatus for purification treatment of wastewater, the mechanism that adds a nutrient adds the nutrient to the treatment system. Accordingly, the degree of activity of PVA-degrading bacteria is increased and the bacterial concentration can be further increased by membrane separation. In addition, the action of the PVA-degrading bacteria is activated by the addition of the nutrient. Consequently, degradation of PVA proceeds, and the occurrence of fouling is suppressed.

The apparatus for purification treatment of wastewater preferably includes an aeration tank that treats the wastewater with a microorganism, in which the mechanism that adds the nutrient is attached to the aeration tank. In the case where the addition of the nutrient by the mechanism that adds the nutrient is performed in the aeration tank in which a treatment is conducted by a microorganism or a membrane separation tank, the bacterial concentration of PVA-degrading bacteria can be effectively increased, and degradation of PVA further proceeds.

The apparatus for purification treatment of wastewater preferably further includes a measurement unit that measures a chemical oxygen demand (COD) and a nitrogen content after a treatment, in which an amount of the nutrient added is adjusted on the basis of the nitrogen content determined by the measurement unit. By adjusting the amount of the nutrient added on the basis of the nitrogen content while checking the COD of treated water, the treatment state of PVA can be more satisfactorily maintained.

The nutrient preferably contains nitrogen. Furthermore, the nutrient may contain a small amount of a phosphorus component or the like. When the nutrient contains nitrogen, the action of PVA-degrading bacteria can be further activated, and degradation of PVA can be accelerated.

An amount of the nutrient initially added is preferably 5% or more and 25% or less in terms of nitrogen relative to the chemical oxygen demand. By controlling the amount of the nutrient initially added within the above range, the action of PVA-degrading bacteria at the start of the purification treatment is activated, and degradation of PVA can be further accelerated.

### Details of Embodiments of the Present Invention

An apparatus for purification treatment of wastewater and a process for purification treatment of wastewater according to embodiments of the present invention will be described with reference to the drawings.

### <Apparatus for Purification Treatment of Wastewater>

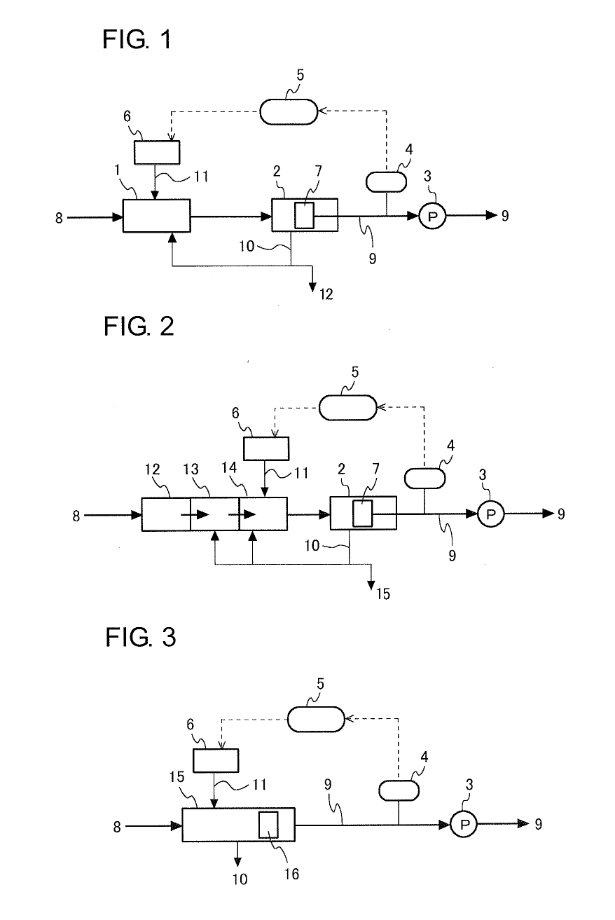

An apparatus for purification treatment of wastewater shown in FIG. 1 is an apparatus for conducting a purification treatment of wastewater 8 containing polyvinyl alcohol (PVA) by using a membrane bioreactor process, and includes a nutrient addition mechanism 6 that adds a nutrient 11 to a treatment system. The apparatus for purification treatment of wastewater includes an aeration tank 1 in which the wastewater 8 is treated with microorganisms, and the nutrient addition mechanism 6 is attached to the aeration tank 1. The apparatus for purification treatment of wastewater includes a membrane separation tank 2 that performs solid-liquid separation of the wastewater 8 purified in the aeration tank 1 into sludge 10 and treated water 9. The apparatus for purification treatment of wastewater further includes a measurement unit 4 that measures a nitrogen content and a chemical oxygen demand (COD) of the treated water 9 after the treatment. The apparatus for purification treatment of wastewater further includes an adjustment unit 5 that adjusts the amount of the nutrient 11 added on the basis of the nitrogen content determined in the measurement unit 4.

### (Aeration Tank)

The aeration tank 1 holds sludge containing aerobic microorganisms. Wastewater 8 is introduced into the aeration tank 1 through a wastewater pipe connected to the aeration tank 1. Subsequently, the wastewater 8 is biologically treated in the aeration tank 1 to produce treated water 9. The aeration tank 1 is connected to the membrane separation tank 2 through a treatment liquid pipe. Water that has been biologically treated in the aeration tank 1 is supplied to the membrane separation tank 2 through the treatment liquid pipe in a state where the water contains sludge. The wastewater 8 introduced into the aeration tank 1 is industrial wastewater containing PVA.

### (Membrane Separation Tank)

A separation membrane 7 is provided in the membrane separation tank 2 in a state where the separation membrane 7 is immersed in a liquid. In the membrane separation tank 2, solid-liquid separation into the sludge 10 and the treated water 9 is performed by the separation membrane 7. The membrane separation tank 2 is connected to the aeration tank 1 through a sludge return pipe. The sludge 10 separated by the separation membrane 7 is returned to the aeration tank 1 through the sludge return pipe. Excess sludge 10 is drained from the sludge return pipe. The treated water 9 separated by the separation membrane 7 is discharged to the outside of the apparatus for purification treatment of wastewater by a suction pump 3.

The separation membrane 7 is not particularly limited as long as the membrane is one that is commonly used in an MBR, and a microfiltration membrane (MF membrane) or an ultra-filtration membrane (UF membrane) can be used. Specifically, examples of the separation membrane 7 that can be used include porous membranes composed of a polyolefin resin such as polyethylene, polypropylene, or chlorinated polyethylene; a polyvinylidene fluoride resin; a polytetrafluoroethylene resin; polystyrene; polyacrylonitrile; cellulose acetate; polysulfone; polyether sulfone; a ceramic; or the like.

The form of the separation membrane 7 may be a flat membrane or a hollow fiber membrane. The flat membrane is a membrane formed so as to have a sheet-like shape. The hollow fiber membrane is a thread-like membrane whose inside is a cavity having an inner diameter of about 3 mm or less.

An air diffusion pipe is provided at the bottom of the membrane separation tank 2 so that the separation membrane 7 is cleaned by aeration.

### (Nutrient Addition Mechanism)

The nutrient addition mechanism 6 continuously adds a nutrient 11 into the aeration tank 1. The amount of the nutrient 11 added by the nutrient addition mechanism 6 to the aeration tank 1 is controlled by the adjusting unit 5.

The sludge 10 contains, for example, bacteria belonging to the genus Pseudomonas, xanthomonas, or the like, the bacteria being microorganisms relating to degradation of PVA. Herein, these bacteria are referred to as “PVA-degrading bacteria”. By adding the nutrient 11 to the aeration tank 1 or the membrane separation tank 2, activity of the PVA-degrading bacteria is increased, and degradation of a PVA component in the wastewater 8 is accelerated. Consequently, the amount of undegraded PVA is decreased, and thus adhesion of undegraded PVA to a surface of the separation membrane 7 in the membrane separation tank 2 is suppressed to suppress an increase in the membrane pressure difference of the separation membrane 7. As a result, a decrease in the filtration performance of the separation membrane 7 is suppressed.

The nutrient 11 added by the nutrient addition mechanism 6 is a nitrogen compound containing nitrogen, such as urea, ammonia, monoethanolamine, an amino acid, ammonium sulfate, ammonium chloride, ammonium nitrate, or tetramethylammonium hydroxide. The nutrient 11 may contain a small amount of a phosphorus component such as diammonium hydrogenphosphate (DAP).

### (Measurement Unit)

The measurement unit 4 samples part of the treated water 9 discharged from the membrane separation tank 2, measures a nitrogen content in the treated water 9, and notifies the measurement result to the adjustment unit 5. The measurement unit 4 also measures a COD of the treated water 9 and notifies the measurement result to the adjustment unit 5.

In FIG. 1, the measurement unit 4 measures the treated water 9 discharged from the membrane separation tank 2. Alternatively, the measurement unit 4 may measure the nitrogen content and the COD of the treated water 9 in the membrane separation tank 2. Alternatively, the measurement unit 4 may measure the nitrogen content and the COD of the treated water 9 after discharged from the suction pump 3.

### (Adjustment Unit)

At the start of the operation of the apparatus for purification treatment of wastewater, the adjustment unit 5 controls the nutrient addition mechanism 6 so that the nutrient 11 is added in an excess amount relative to the COD of the wastewater 8 introduced into the aeration tank 1. The lower limit of the amount of the nutrient 11 that is added excessively by the nutrient addition mechanism 6 at the start of the operation is preferably 5%, and more preferably 10% in terms of nitrogen relative to the COD of the wastewater 8. The upper limit of the amount of the nutrient 11 that is added excessively at this time is preferably 25%, and more preferably 20% in terms of nitrogen relative to the COD of the wastewater 8. When the amount of the nutrient 11 added is smaller than the lower limit, the amount of degradation of PVA at the start of the operation of the apparatus for purification treatment of wastewater is small, and undegraded PVA may adhere to the separation membrane 7 in the membrane separation tank 2. When the amount of the nutrient 11 added exceeds the upper limit, nitrogen may be contained as a contaminant in the treated water 9 and discharged.

After the start of the operation of the apparatus for purification treatment of wastewater, the adjustment unit 5 controls the amount of the nutrient 11 added by the nutrient addition mechanism 6 to the aeration tank 1 in accordance with the nitrogen content and the COD of the treated water 9 notified from the measurement unit 4. Specifically, the adjustment unit 5 confirms that the value of the COD is decreased. When the nitrogen content relative to the COD value is high, the adjustment unit 5 performs a control so as to reduce the amount of the nutrient 11 added by the nutrient addition mechanism 6 to the aeration tank 1 per unit time. Subsequently, the adjustment unit 5 reduces, with time, the amount of the nutrient 11 added by the nutrient addition mechanism 6 to the aeration tank 1 per unit time, and controls the amount of the nutrient 11 added so as to finally reach a constant value.

By adding an excess amount of the nutrient 11 to the aeration tank 1 at the start of the operation of the apparatus for purification treatment of wastewater, the bacterial concentration of the PVA-degrading bacteria is immediately increased. As a result of the increase in the bacterial concentration, degradation of PVA more effectively proceeds. Once degradation of PVA starts to proceed, it is sufficient that the nutrients necessary for maintaining the bacterial concentration be present, and thus it is not necessary to add the nutrient excessively. Therefore, after the start of the operation, the adjustment unit 5 performs a control so as to decrease the amount of the nutrient 11 added.

### <Process for Purification Treatment of Wastewater>

The process for purification treatment of wastewater is a process for conducting a purification treatment of wastewater containing polyvinyl alcohol (PVA) by using a membrane bioreactor process, the process including adding a nutrient 11 to a treatment system. The process for purification treatment of wastewater includes a microorganism treatment step of aerating wastewater 8, in which the nutrient 11 is added in the microorganism treatment step. In addition, the process for purification treatment of wastewater includes a step of measuring a chemical oxygen demand (COD) and a nitrogen content after a treatment, in which an amount of the nutrient 11 added is adjusted on the basis of the nitrogen content determined in this measurement step.

### (Microorganism Treatment Step)

In the microorganism treatment step, at the start of the operation of the apparatus for purification treatment of wastewater, after the wastewater 8 is introduced into the aeration tank 1, the nutrient addition mechanism 6 adds the nutrient 11 to the aeration tank 1 in an excess amount relative to the COD of the wastewater 8.

During the operation of the apparatus for purification treatment of wastewater, the temperature of the wastewater 8 in the aeration tank 1 is maintained at a temperature suitable for the progress of degradation of PVA. The lower limit of the temperature of the wastewater 8 in the aeration tank 1 at this time is preferably 25° C., and more preferably 27° C. The upper limit of the temperature of the wastewater 8 in the aeration tank 1 at this time is preferably 38° C., and more preferably 35° C. When the temperature of the wastewater 8 in the aeration tank 1 is lower than the lower limit, PVA may not be easily degraded. Also, when the temperature of the wastewater 8 in the aeration tank 1 exceeds the upper limit, PVA may not be easily degraded. Specifically, the temperature of the wastewater 8 in the aeration tank 1 may be controlled to 30° C. as a target. A sludge retention time (SRT) is preferably as long as possible and preferably about 50 days or more, if possible.

After the start of the operation of the apparatus for purification treatment of wastewater, the nutrient addition mechanism 6 continuously adds the nutrient 11 to the aeration tank 1. In this case, the nutrient 11 is added by the nutrient addition mechanism 6 to the aeration tank 1 in accordance with the amount per unit time determined by the adjustment unit 5.

Activity of PVA-degrading bacteria in the aeration tank 1 is increased by adding the nutrient 11 to the aeration tank 1 to accelerate degradation of a PVA component in the wastewater 8. Consequently, the COD of the treated water 9 after being purified in the aeration tank 1 significantly decreases relative to the COD of the wastewater 8.

### (COD Measurement Step)

In the COD measurement step, the measurement unit 4 samples part of the treated water 9 and measures the nitrogen content and the COD. The measurement unit 4 notifies the measurement results to the adjustment unit 5.

### (Step of Adjusting Amount of Nutrient Added)

In the step of adjusting an amount of nutrient added, when the adjustment unit 5 confirms that the COD of the treated water 9 is decreased, the adjustment unit 5 controls the amount of the nutrient 11 added by the nutrient addition mechanism 6 to the aeration tank 1 per unit time to be reduced with time in order to reduce the nitrogen content of the treated water 9. In this case, the adjustment unit 5 determines the amount of the nutrient 11 added to the aeration tank 1 per unit time in accordance with the nitrogen content measured by the measurement unit 4. The adjustment unit 5 controls the amount of the nutrient 11 added per unit time so as to finally reach a constant value.

As described above, the apparatus for purification treatment of wastewater considers the nitrogen content of the treated water 9 to be excessive, and corrects the amount of nitrogen injected (amount of the nutrient 11 added) so that the amount of nitrogen injected does not become excessive while confirming the decrease in the COD. For example, in the case where the nitrogen content of the treated water 9 is 100 mg/L, the adjustment unit 5 performs a control such that the amount of the nutrient 11 added is reduced by 100 mg/L.

Note that, in the case where nitrite nitrogen (NO₂—N) remains in the treated water 9, a value including a COD generated by NO₂—N is measured as the COD value of the treated water 9. Therefore, the adjustment unit 5 calculates the COD generated by NO₂—N and corrects the measured value of the COD of the treated water 9.

### [Advantages]

According to the apparatus for purification treatment of wastewater, the bacterial concentration of PVA-degrading bacteria can be increased as a result of the addition of the nutrient 11 to the aeration tank 1 by the nutrient addition mechanism 6. In addition, the action of the PVA-degrading bacteria can be activated by the addition of the nutrient 11. Accordingly, degradation of PVA proceeds, and the occurrence of fouling of the separation membrane is suppressed.

In addition, according to the apparatus for purification treatment of wastewater, since the nutrient 11 added to the aeration tank 1 contains nitrogen, degradation of PVA can be accelerated.

Furthermore, according to the apparatus for purification treatment of wastewater, by initially adding the nutrient 11 in an excess amount relative to the COD of the wastewater 8, the action of the PVA-degrading bacteria at the start of the operation of the apparatus for purification treatment of wastewater is activated to accelerate degradation of PVA. In addition, the apparatus for purification treatment of wastewater subsequently controls the amount of the nutrient 11 added in accordance with the COD and the nitrogen content of the treated water 9. Thus, the apparatus for purification treatment of wastewater decreases the nitrogen content of the treated water and confirms that the COD is decreased, while maintaining a state in which the PVA-degrading bacteria are activated.

### OTHER EMBODIMENTS

It is to be understood that the embodiments disclosed herein are only illustrative and are not restrictive in all respects. The scope of the present invention is not limited to the configurations of the embodiments but is defined by the claims described below. It is intended that the scope of the present invention includes equivalents of the claims and all modifications within the scope of the claims.

In the above embodiments, the wastewater 8 is introduced directly into the aeration tank 1. Alternatively, solid matter contained in the wastewater 8 may be separated by a screen that is commonly used, and the wastewater 8 after the removal of the solid matter may be introduced into the aeration tank 1. In this case, the occurrence of fouling of the separation membrane 7 due to mixing of solid matter can be prevented.

In the above embodiments, the nutrient 11 is added automatically to the aeration tank 1 by the nutrient addition mechanism 6. Alternatively, the nutrient 11 may be fed manually to the aeration tank 1 instead of using the nutrient addition mechanism 6. Specifically, at the start of the operation, an excess amount of the nutrient 11 may be manually taken out from a chemical bag and fed to the aeration tank 1. After the start of the operation, the nutrient 11 may be manually weighed from the chemical bag in an amount calculated by the adjustment unit 5, and then fed to the aeration tank 1.

In the above embodiments, the measurement unit 4 is permanently installed in the treatment system. Alternatively, the nitrogen content and the COD of the treated water 9 may be timely sampled with, for example, a handy meter or the like.

In the above embodiments, the nutrient 11 is added to the aeration tank 1. Alternatively, the nutrient 11 may be added to the membrane separation tank 2. Alternatively, the nutrient 11 may be added to both the aeration tank 1 and the membrane separation tank 2.

In the above embodiments, the wastewater 8 is purified in the aeration tank 1. Alternatively, as shown in an apparatus for purification treatment of wastewater in FIG. 2, purification may be performed in an anaerobic tank 12, an anoxic tank 13, and an oxic tank 14. In FIG. 2, components the same as those shown in FIG. 1 are assigned the same reference numerals, and the description of those components is omitted. In FIG. 2, a nutrient 11 is added to the oxic tank 14. Alternatively, the nutrient 11 may be added to the anoxic tank 13. Alternatively, the nutrient 11 may be added to both the oxic tank 14 and the anoxic tank 13. With this configuration, the PVA-degrading bacteria can be activated more significantly. Thus, the purification efficiency can be improved.

In the above embodiments, the PVA-degrading bacteria are activated by adding an excess amount of the nutrient 11 at the start of the operation. Subsequently, an excessively high nitrogen content of the treated water 9 is reduced by reducing the amount of the nutrient 11 added. Alternatively, the excessive amount of nitrogen may be reduced by providing a denitrification tank in the treatment system of the apparatus for purification treatment of wastewater.

In FIGS. 1 and 2, the apparatuses are each a separate installation-type apparatus in which the membrane separation tank 2 is provided separately from a reaction tank. Alternatively, the apparatus may be a single tank-type apparatus in which a separation membrane is provided in a reaction tank.

FIG. 3 shows a block diagram of a single tank-type apparatus for purification treatment of wastewater in which a separation membrane 16 is provided in an aeration tank 15. In FIG. 3, components the same as those shown in FIG. 1 are assigned the same reference numerals, and the description of those components is omitted. The form of the separation membrane 16 in FIG. 3 is a hollow fiber membrane. In this single tank-type apparatus, it is not necessary to provide a mechanism for returning sludge separated by the separation membrane 16 to a reaction tank. Thus, the apparatus for purification treatment of wastewater can have a compact and simple structure.

### EXAMPLES

The present invention will now be more specifically described using Examples. The present invention is not limited to the Examples described below.

Wastewater from a dyehouse (biochemical oxygen demand (BOD) concentration: 390 mg/L) was used as wastewater introduced to an apparatus for purification treatment of wastewater. A hydraulic retention time in the apparatus for purification treatment of wastewater was 72 hours. At the start of the operation, activated sludge in an aeration tank was supplied so that the mixed liquor suspended solids (MLSS) concentration of water to be treated became 8,000 mg/L. The activated sludge was drained as required such that, during the operation, the MLSS concentration of water to be treated became 7,000 to 12,000 mg/L.

### Example 1

Purification treatment of the wastewater was conducted by using the apparatus for purification treatment of wastewater for a membrane bioreactor process, as shown in FIG. 1. A hollow fiber membrane element including a microfiltration membrane composed of polyvinylidene fluoride (PVDF) and having a nominal pore size of 0.1 μm was used as a separation membrane in a membrane separation tank.

At the start of the operation, urea having a nitrogen content of 20% of the COD (1,100 mg/L) of the wastewater was added as a nutrient to the aeration tank. After the start of the operation, the nutrient was continuously added to the aeration tank while reducing the amount of the nutrient added per unit time in accordance with the COD and the nitrogen content of treated water after being separated in the membrane separation tank. During the operation, water temperatures in the aeration tank and the membrane separation tank were maintained at 30° C.

### Comparative Example 1

Purification treatment of the wastewater was conducted by an existing activated sludge process. Specifically, the wastewater was purified in an aeration tank, and water purified in the aeration tank was then supplied to a settling tank. Activate sludge was naturally settled in the settling tank and separated from a supernatant. The supernatant was obtained as treated water.

### Comparative Example 2

Purification treatment of the wastewater was conducted by using the apparatus for purification treatment of wastewater for a membrane bioreactor process, the apparatus being the same as that used in Example 1, without adding the nutrient to the aeration tank. This purification treatment differs from the purification treatment of Example 1 only in that the nutrient was not added.

### (Measurement of BOD)

With regard to Example 1 and Comparative Example 2, the BOD of treated water discharged from the apparatus for purification treatment of wastewater after being operated for 24 days or more was measured in accordance with JIS K-0102 (testing methods for industrial wastewater).

### (Measurement of COD)

With regard to Example 1, Comparative Example 1, and Comparative Example 2, the COD of treated water discharged from the apparatus for purification treatment of wastewater after being operated for 24 days or more was measured in accordance with JIS K-0102 (testing methods for industrial wastewater). With regard to Example 1 and Comparative Example 2, the COD of water in the membrane separation tank was also determined. In Example 1 and Comparative Example 2, filtered water prepared by filtering suspended solids (SS) in the membrane separation tank with 1-μm filter paper was analyzed to determine the COD.

### (Measurement of PVA)

With regard to Example 1, Comparative Example 1, and Comparative Example 2, the concentrations of PVA in treated water discharged from the apparatus for purification treatment of wastewater after being operated for 24 days or more were measured by a boric acid addition iodine colorimetric assay method. With regard to Example 1 and Comparative Example 2, the concentrations of PVA in water in the membrane separation tank were also determined.

Table I shows the measurement results. Measured values of the wastewater (raw water) introduced in the apparatus for purification treatment of wastewater of each of Example 1, Comparative Example 1, and Comparative Example 2 are also shown in Table I. In Table I, the term “nutrient-added MBR” denotes the apparatus for purification treatment of wastewater of Example 1, the term “settling tank in activated sludge process” denotes the settling tank of the apparatus for purification treatment of wastewater for the existing activated sludge process in Comparative Example 1, and the term “nutrient-free MBR” denotes the apparatus for purification treatment of wastewater of Comparative Example 2.

TABLE I

| | BOD | COD | PVA |
|---|---|---|---|
| | (mg/L) | (mg/L) | (mg/L) |
| Raw water | 390 | 1100 | 600 |
| Membrane separation tank of nutrient-added | — | 190 | 7 |
| MBR | | | |
| Treated water in nutrient-added MBR | <1 | 40 | 9 |
| Settling tank in activated sludge process | — | 480 | 450 |
| Membrane separation tank of nutrient-free | — | 2200 | 2100 |
| MBR | | | |
| Treated water in nutrient-free MBR | 10 | 160 | 110 |

The symbol “<1” shown in Table I denotes that the value was equal to or less than a minimum measurable value of a measurement device. Specifically, the BOD of Example 1 was 1 mg/L or less. Table I shows that the BOD in each of the membrane separation tanks of the MBR and the BOD in the settling tank in the existing activated sludge process were not measured.

The water temperatures and pH values of the raw water, water in the membrane separation tanks, and the treated water treated in the apparatuses for purification treatment of wastewater were also measured. The water temperatures were in the range of 20° C. or higher and 30° C. or lower, and the pH values were in the range of 7.5 or more and 8.6 or less.

Referring to the results shown in Table I, in the case where an apparatus for purification treatment of wastewater for a membrane bioreactor process (MBR process) was used, both the COD and the PVA were smaller than those in the case where the apparatus for purification treatment of wastewater for the existing precipitation method was used. These results show that the COD and the PVA of treated water can be significantly reduced by using the membrane bioreactor process (MBR process).

The difference between the addition and non-addition of the nutrient in the MBR process will be discussed. In the case where the nutrient was added, the COD was lower than that in the case where the nutrient was not added. In the case where the nutrient was added, the PVA was decreased significantly (to 1/10 or less) compared with the case where the nutrient was not added. This is because activity of the PVA-degrading bacteria was increased and degradation of the PVA component was accelerated by adding, as the nutrient, urea, which contains nitrogen. These results show that the addition of the nutrient significantly affects the acceleration of degradation of PVA.

With regard to the cases where the addition of the nutrient was performed and not performed in the MBR, membrane pressure differences of the separation membrane were examined before and after the operation of the apparatus for purification treatment of wastewater. In the case where the nutrient was added, a change in the membrane pressure difference of the separation membrane was not observed before and after the operation of the apparatus for purification treatment of wastewater. In contrast, in the case where the nutrient was not added, the membrane pressure difference after the operation was increased by 0.34 kPa/d compared with the membrane pressure difference before the operation. This is probably because in the case where the nutrient was not added, undegraded PVA was concentrated on the upstream side of the membrane and adhered to the separation membrane. These results show that the occurrence of fouling of a separation membrane can be prevented by adding a nutrient.

### <Examination of Effect of Amount of Nutrient Added>

In Example 1, after 14 days from the start of the operation, the amount of the nutrient added per hour reached a constant amount having a nitrogen content of 5% to 10% of the COD of the wastewater.

In Example 1, the amount of the nutrient added at the start of the operation was set to an amount having a nitrogen content of 20% of the COD of the wastewater. Consequently, after 14 days from the start of the operation, the amount of the nutrient added per hour reached a constant amount having a nitrogen content of 5% to 10% of the COD of the wastewater. In this case, the PVA in the treated water after 14 days from the start of the operation was 9 mg/L, and thus a decrease in PVA equivalent to that of Example 1 was observed.

### INDUSTRIAL APPLICABILITY

The process for purification treatment of wastewater and the apparatus for purification treatment of wastewater of the present invention can accelerate degradation of PVA, suppress the occurrence of fouling, and satisfactorily maintain the treatment state of PVA, as described above. Accordingly, the process for purification treatment of wastewater and the apparatus for purification treatment of wastewater of the present invention are suitable for use as, for example, an apparatus for purification treatment of wastewater for treating wastewater that contains a large amount of industrial wastewater containing PVA, etc.

1. A process for purification treatment of wastewater for conducting a purification treatment of wastewater containing polyvinyl alcohol by using a membrane bioreactor process (MBR process),
the process comprising adding a nutrient to a treatment system.

2. The process for purification treatment of wastewater according to claim 1, comprising a microorganism treatment step of aerating the wastewater,
wherein the nutrient is added in the microorganism treatment step.

3. The process for purification treatment of wastewater according to claim 1, wherein the nutrient contains nitrogen.

4. The process for purification treatment of wastewater according to claim 1, comprising a step of measuring a nitrogen content after a treatment,
wherein an amount of the nutrient added is adjusted on the basis of the nitrogen content determined in the measurement step.

5. The process for purification treatment of wastewater according to claim 1, wherein an amount of the nutrient initially added is 5% or more and 25% or less in terms of nitrogen relative to a chemical oxygen demand of the wastewater.

6. An apparatus for purification treatment of wastewater for conducting a purification treatment of wastewater containing polyvinyl alcohol by using a membrane bioreactor process,
the apparatus comprising a mechanism that adds a nutrient to a treatment system.

7. The apparatus for purification treatment of wastewater according to claim 6, comprising an aeration tank that treats the wastewater with a microorganism,
wherein the mechanism that adds the nutrient is attached to the aeration tank.

8. The apparatus for purification treatment of wastewater according to claim 6, wherein the nutrient contains nitrogen.

9. The apparatus for purification treatment of wastewater according to claim 6, further comprising a measurement unit that measures a chemical oxygen demand and a nitrogen content after a treatment,
wherein an amount of the nutrient added is adjusted on the basis of the nitrogen content determined by the measurement unit.

10. The apparatus for purification treatment of wastewater according to claim 6, wherein an amount of the nutrient initially added is 5% or more and 25% or less in terms of nitrogen relative to the chemical oxygen demand.
